(19) United States
(12) Patent Application Publication
(10) Pub. No.: US 2013/0016012 A1
(43) Pub. Date: Jan. 17, 2013

(54) METHOD AND/OR APPARATUS FOR BACKTRACKING POSITION ESTIMATION

(71) Applicant: Stephen J. Beauregard, Santa Clara, CA (US)

(72) Inventor: Stephen J. Beauregard, Santa Clara, CA (US)

(73) Assignee: QUALCOMM Incorporated, San Diego, CA (US)

(21) Appl. No.: 13/548,032

(22) Filed: Jul. 12, 2012

Related U.S. Application Data
(60) Provisional application No. 61/507,997, filed on Jul. 14, 2011.

(51) Int. Cl. G01S 3/02

(52) U.S. Cl. 342/450

(57) ABSTRACT

Disclosed are methods, systems and apparatuses for computing position fixes according to a motion model. Particles may be propagated based, at least in part, on measurements received at a mobile device according to the motion model. A particular cluster of the propagated particles may then be selected to represent a state of the mobile device based, at least in part, on weights applied to particles in the clusters. The selected clusters may be retroactively changed so that the sequence of position fixes satisfies geometrical and dynamic feasibility constraints. The updated sequence of position fixes can be made available to high-level navigation applications for instance for user track display updating.

This application claims the benefit of priority to U.S. Provisional Patent Application No. 61/507,997 for “Method and/or Apparatus for Backtracking Position Estimation,” filed on Jul. 14, 2011.

### BACKGROUND

Mobile devices can typically obtain a position fix by measuring ranges to three or more terrestrial transmitters (e.g., wireless access points) which are positioned at known locations. Such ranges may be measured, for example, by obtaining a MAC ID address from signals received from such access points and measuring one or more characteristics of signals received from such access points such as, for example, signal strength, round trip delay, just to name a few examples. Such measurements may be viewed as “direct measurements” in that they give information regarding a current position (such as a range to a transmitter fixed at a known location) when obtained.

Typically, measurements of ranges to only three ground-based transmitters positioned at known, fixed locations is sufficient for obtaining a sufficiently accurate estimate of a location of the mobile device. In a particular example where measurements of ranges to more than three transmitters is available, the accuracy of such an estimate may vary considerably based upon which particular measurements to which particular transmitters are selected for obtaining such an estimate of a location of a mobile device. For example, an inaccuracy in a measurement of a range to at least one transmitter can significantly degrade the accuracy of a resulting estimate a location of a mobile device.

In addition to the use of direct measurements, a mobile device may incorporate “indirect measurements” indicative of relative motion to assist in obtaining an estimate of a current position estimate. Such indirect measurements may include, for example, measurements obtained from signals generated by sensors such as, for example, accelerometers, pedometers, compasses or gyroscopes. Also, in certain environments and applications, movement of a mobile device may be constrained to predetermined areas or paths. In an indoor environment, for example, movement of a mobile device may be constrained to predetermined paths or routes defined according to walls, doorways, entrances, stairways, etc. As such, a current location of a mobile device may be presumed to be constrained by such predetermined areas or paths. However, merely constraining a mobile station's location to a path may not, without additional information, indicate a location of the mobile device with sufficient precision to useful in certain location based applications. Here, the precise location of the mobile device is still uncertain as the location may be anywhere along, or at least proximate to, any portion of a predetermined path.

In particular implementations, a “position fix” may comprise an estimated location of a mobile device according to a reference frame (e.g., according to a global or local coordinate system). For example, a position fix may generated, obtained and/or computed at a mobile device based, at least in part, on direct measurements, indirect measurements described above, or combinations thereof. While a finite number of measurements alone may yield an ambiguous location, application of navigation constraints (e.g., defining navigable regions) may reduce ambiguities in a position fix and/or allow for computation of a position fix characterizing a unique location estimate. Depending on the availability of measurement sources for obtaining position fix, the accuracy of a position fix may vary widely.

### BRIEF DESCRIPTION OF THE FIGURES

FIG. 1 is a plot of an example of retroactively updating a tracked path of a mobile device according to an implementation.

FIG. 2 is a plot of an example of path smoothing according to an implementation.

FIG. 3 is a diagram of a system for applying a post filter to tracking filter according to an implementation.

FIG. 4 is a flow diagram of a process including post filtering to a tracking filter according to an implementation.

FIG. 5 is a schematic diagram illustrating an example computing environment associated with a mobile device according to an implementation.

### SUMMARY

In one aspect, a method comprises: propagating particles based, at least in part, on measurements received at a mobile device according to a motion model; associating the plurality of particles into a plurality of clusters; selecting one of the plurality of clusters as being representative of a location of the mobile device at an instance of time based, at least in part, on weights assigned to particles in the clusters; and altering position fixes prior to the instance in time based, at least in part, on the selected one of the plurality of clusters.

In another aspect, a mobile device comprises: at least one sensor; and a processor to: propagate particles based, at least in part, on measurements obtained from the at least one sensor according to a motion model; associate the plurality of particles into a plurality of clusters; select one of the plurality of clusters as being representative of a current position of the mobile device based, at least in part, on weights assigned to particles in the clusters; and alter past position fixes based, at least in part, on the selected one of the plurality of clusters.

An article comprising: a non-transitory storage medium comprising machine-readable instructions stored thereon which are executable by a special purpose computing apparatus to: propagate particles based, at least in part, on measurements received at a mobile device according to a motion model; associate the plurality of particles into a plurality of clusters; select one of the plurality of clusters as being representative of a current position of the mobile device based, at least in part, on weights assigned to particles in the clusters; and alter past position fixes based, at least in part, on the selected one of the plurality of clusters.

An apparatus comprising: means for propagating particles based, at least in part, on measurements received at a mobile device according to a motion model; means for associating the plurality of particles into a plurality of clusters; means for selecting one of the plurality of clusters as being representative of a current position of the mobile device based, at least in part, on weights assigned to particles in the clusters; and means for altering past position fixes based, at least in part, on the selected one of the plurality of clusters.

It should be understood, however, that these are merely example implementations, and that claimed subject matter is not limited in these respects.

### DETAILED DESCRIPTION

Real-time position estimation methods may use information of many different types (e.g., measurements, dynamic models and map constraints) available up to a current time point to provide a “best” possible position estimate. One such technique includes particle filtering. Estimating a trajectory of an object (such as a mobile device) by application of a motion model such as particle filtering may include obtaining measurements (e.g., from sensors such as a radio frequency (RF) receiver), and processing the measurements to formulate multiple hypotheses. Here, while multiple measurements may be obtained at a mobile device (e.g., measurements obtained from acquisition of signals transmitted by transmitters at known, fixed locations and/or measurements obtained at inertial sensors), a location state or motion state of the mobile device may still be ambiguous. Ambiguities in a mobile device's location state or mobile state may then be resolved by application of a maximum likelihood estimator applied to multiple hypotheses.

Unfortunately, an application of a maximum likelihood estimator to multiple hypotheses of a mobile device's location state and/or motion state may select a hypotheses including an erroneous location state and/or motion state. Position fixes based on an erroneous location state and/or motion state may distort a trajectory of the tracked mobile device to deviate from an actual history of a mobile device's movement. Also, a sequence of real-time position fixes (e.g., going “forwards in time”) obtained from erroneous selection of a location state and/or motion state may not necessarily correspond to a realistic or even feasible path in an indoor area. For instance, a heading of a moving object may appear to change suddenly, or the path may appear to jump across obstacles (in the case of map-aided positioning).

These kinds of path jumps may not meet the requirements of applications relying on real-time position fixes and may be unacceptable from an end user experience perspective. Here, a particular implementation of a particle filter for an in-door navigation application may exhibit the following characteristics:

1. a mean position of particles may not necessarily be constrained by walls and may wander along an infeasible path;

2. measurements (e.g., received signal strength (RSSI) or round trip time (RTT) measurements) may be occasionally erroneous or vague, giving rise to multiple competing hypotheses at any particular instance along a tracked trajectory; and

3. if a past hypothesis choice is incorrect, then a path may appear to jump suddenly

(See, e.g., Evennou, F.; Marx, F.; Novakov, E.; , “Map-aided indoor mobile positioning system using particle filter,” Wireless Communications and Networking Conference, 2005 IEEE , vol.4, no., pp. 2490-2494 Vol. 4, 13-17 Mar. 2005, and Beauregard, S.; Widyawan; Klepal, M.;, “Indoor PDR performance enhancement using minimal map information and particle filters,” Position, Location and Navigation Symposium, 2008 IEEE/ION , vol., no., pp.141-147, 5-8 May 2008).

In a particular implementation, a particular process may mitigate the types of path anomalies described above for improving performance of mobile applications relying on position fixes and/or end-user experience. First, a real-time path presented to an end user may better satisfy particular dynamics (e.g., speed) and geometrical constraints (e.g., walls and other physical obstructions). Second, an estimated path or trajectory may be corrected “backwards in time” if the most recent position estimate is incompatible with previous estimates. For example, if there were multiple competing position hypotheses at various time points in the past, a set of hypotheses may be selected to be compatible with a most recent estimate (e.g., position fix and/or motion state). An updated track may then be further smoothed (e.g., using a Kalman smoother with an appropriate motion model) to better mimic pedestrian dynamics. Third, a corrected path may be made available to user-space navigation applications via special positioning engine application programming interface (API) facilities hosted on a special purpose computing apparatus of a mobile device. It should be understood, however, that these are merely examples of techniques described herein, and that claimed subject matter is not limited in this respect.

In certain implementations, a special positioning engine API may include corrected or “backtracked” position fixes in a bundle class instance (e.g., in an Android™ platform) attached as extra information to messages carrying a real-time position fix. Applications using the real-time position fix (e.g., graphical user interface, routing functions, etc.) may then apply the corrected or backtracked position fixes in computing a “corrected” trajectory. For instance, end-user graphical interfaces may update a displayed track (e.g., on a display device as part of a special purpose computing apparatus) for points in the past based, at least in part, on corrected or backtracked position fixes. Also, a routing function (e.g., as part of an application program hosted on a special purpose computing apparatus) may use an updated track to dynamically update a proposed route. It should be understood, however, that these are merely examples of how corrected or backtracked position fixes may be applied in particular implementations, and claimed subject matter is not limited in this respect.

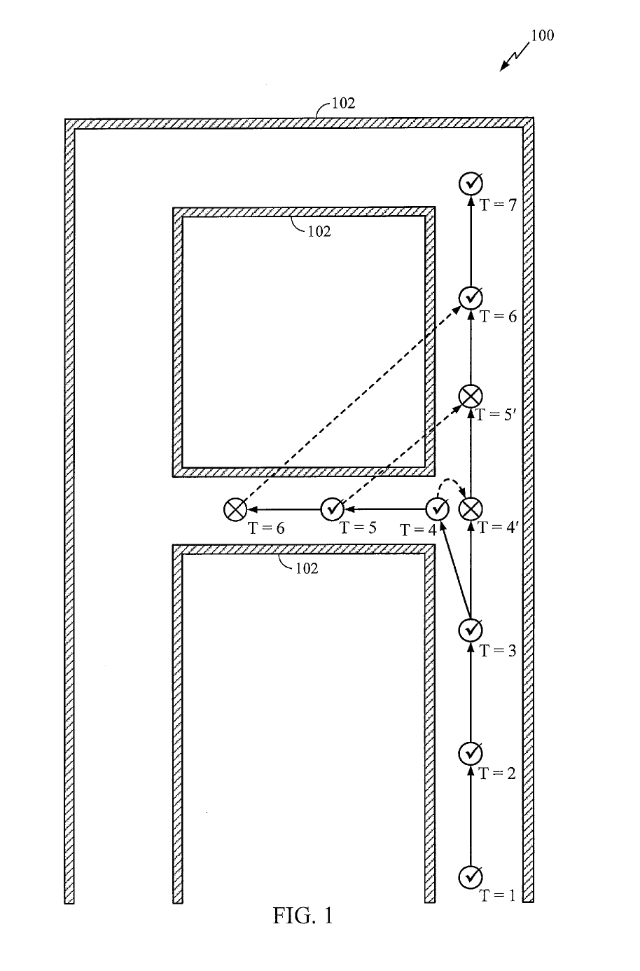

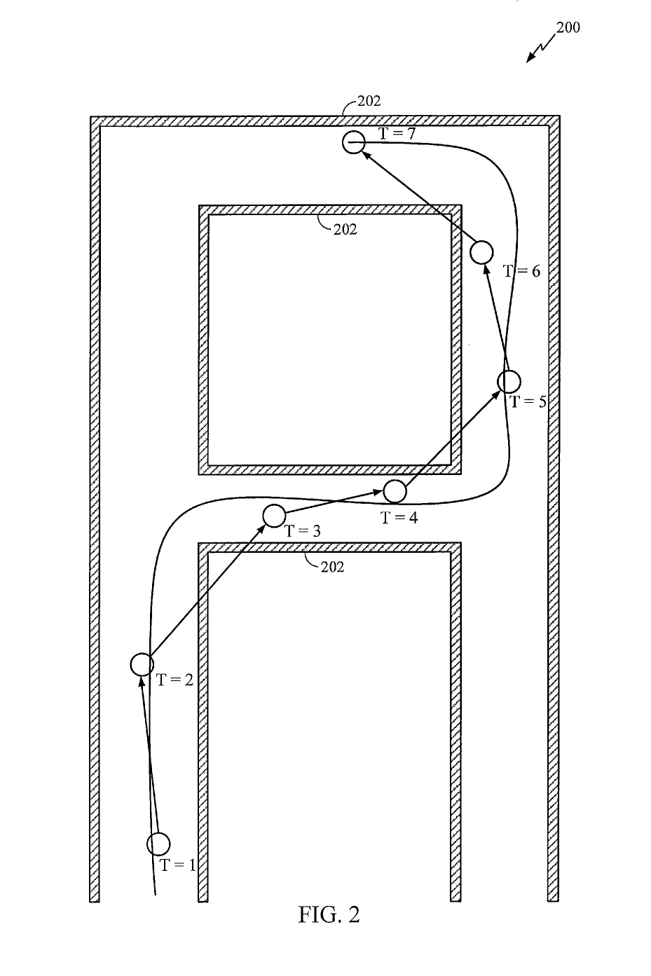

The plots of FIGS. 1 and 2 illustrate a particular aspects of application of post filter techniques to a series of position fixes to generate a trajectory according to an implementation. In this particular example, a trajectory may be computed from a series of position fixes (e.g., by applying a filter to the series of position fixes according to a motion model) and is laid over an indoor navigation infrastructure comprising walls 102 and 202. Here, walls 102 and 202 provide bounds or constraints to define areas that are feasible for indoor navigation (e.g., a trajectory should not be computed to pass through walls or other known physical barriers). It should be understood, however, that walls 102 and 202 presented in FIGS. 1 and 2 are merely as examples of physical barriers that may bind or constrain areas feasible for indoor navigation. Other types of barriers bounding a feasible indoor navigation space may also be defined. Also, while not shown in FIGS. 1 and 2, openings through barriers (e.g., a doorway in a wall separating adjacent rooms) may define a feasible area through which a mobile device may pass between two navigable areas separated by a wall or other partition. While indoor navigation areas 100 and 200 are shown in FIGS. 1 and 2 to illustrate a how a trajectory may be plotted from a series of position fixes, indoor navigation areas 100 and 200 may also be presented on a display of a mobile device as part of a navigation application that is hosted on the mobile device via an API.

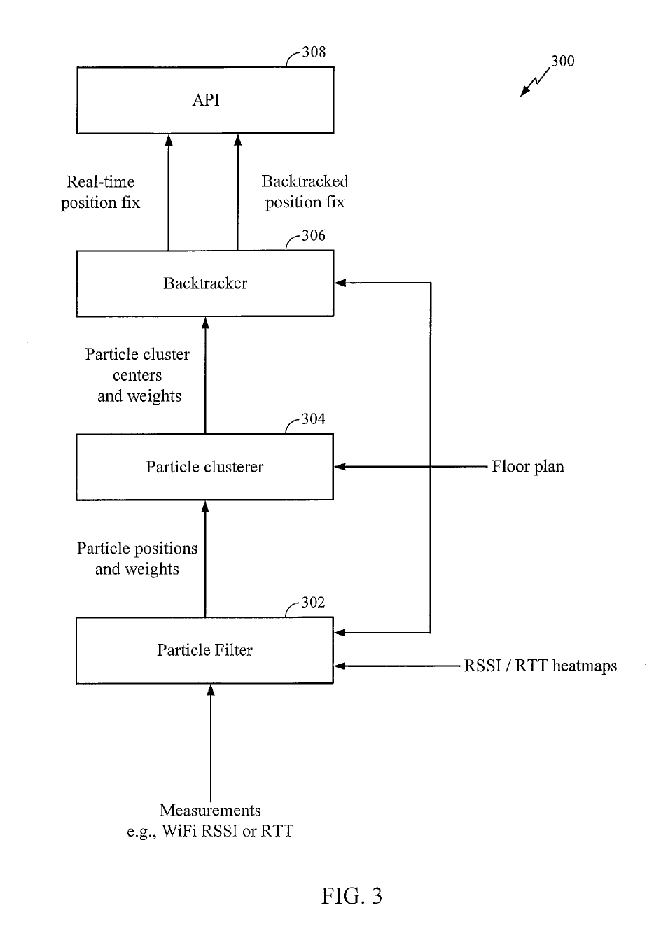

In particular implementations, points denoted “T=n” represent locations of position fixes obtained in real-time at time n while points denoted “T=n′” represent position fixes for time n which are retroactively obtained or adjusted responsive to subsequent measurements or inferences. Here, it can be observed that position fixes T=4, T=5 and T=6, while appearing feasible up to time n=6, in retrospect do not appear feasible at time n=7 as position fix T=7 is obtained. To account for new information in position fix T=7, past hypotheses for obtaining position fixes T=4, T=5 and T=6 based on routing constraints (e.g., walls or other obstacles constraining an area feasible for navigation) may be revisited and position fixes T=4, T=5 and T=6 may be retroactively updated as position fixes T=4′, T=5′ and T=6′ in accordance with the most recently obtained position fix T=7. FIG. 2 shows an example of application of a smoothing filter to account for non-wall-cross constraints. In a particular implementation, such a smoothing filter may comprise a Kalman filter for computing an estimated state (e.g., an estimated location and/or velocity) at a current time based on past measurements. In an alternative implementation, such a smoothing filter may comprise a Kalman smoother capable of computing an estimated state at a particular instance in time based on measurements obtained before the particular instance in the past, and measurements obtained following the particular instance of time. Here, with a Kalman smoother, position fixes obtained at any particular instance in time on a trajectory may adjusted or updated based, at least in part, on position fixes obtained prior to the particular instance in time and on position fixes obtained following the particular instance in time. While particular embodiments discussed herein are directed to backtracking to correct past position fixes for generating a trajectory to support a real-time application, other implementations may be applied to correcting a previous position in an off-line analysis application (e.g., to assess past behavior evidenced by past position fixes obtained by mobile devices in a particular area). FIG. 3 is a flow diagram of a system 300 for applying a post filter to position fixes obtained by a particle filter according to an implementation. In this particular implementation, system 300 may be executed according to instructions stored on a non-transitory storage medium by a special purpose computing apparatus (e.g., on a mobile device). For example, an API 308 may be hosted on a special purpose computing apparatus to provide position fixes in real-time to applications such as, for example, various navigation applications as discussed above. It should be understood, however, that this is merely an example of process to implement a process of backtracking over position fixes in an estimated trajectory, and that claimed subject matter is not limited in this respect.

A particle filter 302 may receive measurements such as, for example, received signal strength indications (RSSI), round trip times (RTT) in connection with signal received from known transmitters. Additional measurements may include, for example, measurements obtained from inertial sensors such as accelerometers, magnetometers, gyroscopes or the like. Aiding information such as RSSI/RTT heatmaps may also incorporated. Here, a heatmap may associated specific locations in an indoor navigation area with expected signatures (e.g., expected RSSI or RTT based on signals transmitted from known and identifiable transmitters). Using techniques known to those of ordinary skill in the art, a mobile station may compute a position fix based, at least in part, on an association of characteristics of acquired signals (e.g., RSSI or RTT of acquired signals) with heatmap signatures. Other aiding information may include known locations of transmitters which may allow for computing position fixes by estimating ranges to these locations (e.g., based, at least in part on RSSI or RTT measurements using techniques known to those of ordinary skill in the art), and performing trilateration based, at least in part, on the estimated ranges.

In determining a position fix in real-time, a particle filter may update or propagate particles representing possible states of a mobile device (e.g., position and directional velocity), and assign weights or likelihoods to the particles. In one aspect, a final position fix may not be merely selected as a weighted mean of the propagated particles. In one particular implementation, motion of individual particles may be constrained based, at least in part, on known motion constraints (e.g., as discussed above in connection with FIGS. 1 and 2). For example, particles representing possible states that cross walls or other physical barriers may be eliminated from a particle “cloud” and replacements may be obtained from a remainder. (See, e.g., Evennou, F.; Marx, F.; Novakov, E.; , “Map-aided indoor mobile positioning system using particle filter,” Wireless Communications and Networking Conference, 2005 IEEE , vol.4, no., pp. 2490-2494 Vol. 4, 13-17 Mar. 2005, and Beauregard, S.; Widyawan; Klepal, M.; , “Indoor PDR performance enhancement using minimal map information and particle filters,” Position, Location and Navigation Symposium, 2008 IEEE/ION , vol., no., pp.141-147, 5-8 May 2008).

In one implementation, particle positions and weights may be processed by a particle clusterer 304 to associate particles into clusters. Any one of several techniques may be used for associating particles into clusters. In one example, particles may be clustered based, at least in part, on movement constraints as determined from a floor plan. In a particular implementation, particle clusterer 304 may separate an entire particle cloud into sub-clusters, and then calculate a mean position of each subcluster as well as the sum of the weights in the cluster. At this point, a number of clusters may be unknown. However, well known clustering techniques such as Affinity Propagation Clustering may be applied without a priori knowledge of a number clusters (see, e.g. “Clustering by Passing Messages Between Data Points” Brendan J. Frey and Delbert Dueck, University of Toronto, Science 315, 972-976, February 2007). To apply Affinity Propagation Clustering, a so-called affinity matrix may be filled with an inverse of the Euclidean distance between pairs of particles. Here, the closer particles are to one another, the more likely they are to belong to the same cluster. The speed and convergence properties of an Affinity Propagation Clustering process may be improved by incorporating particle pair wise visibility attributes. Pairs of particles that are not in line-of-sight (LOS) of one another may be determined to not be in the same cluster so the corresponding affinity matrix entry is set to zero. The LOS test can be done very quickly with a line intersection test between the line connecting the particles and the lines representing the floor plan walls.

In an alternative implementation, particle clusterer 304 may pre-compute polygonal patches on a floor plan using known techniques, and then determine which patch each particle is in. Here, a mean position of particles in patch can then be calculated easily. For typical floor plans, patches may be easily identified with separate room and corridor segments providing a natural spatial decomposition of the floor plan for navigation and positioning applications. It should be understood, however, that these are merely example techniques for clustering particles and that claimed subject matter is not limited in this respect.

Based, at least in part, on particle cluster centers and weights obtained from particle clusterer 304, a backtracker 306 may provide backtracked position fixes as discussed above. In one implementation, backtracker 306 may execute as follows:

At a current time t₀, a weightiest cluster from particle clusterer 304 may be chosen as a most likely location of a current position fix Xₜ_{₀};

If a line segment between the most likely location of current position fix Xₜ_{₀} and a location of a previous position fix Xₜ_{_{−1}} crosses an obstacle in the floor plan:

1. Ignore the location of previous position fix Xₜ_{_{−1}} and project a line segment between locations of position fixes Xₜ_{₀} and Xₜ_{_{−2}} (location of a position fix immediately preceding position fix Xₜ_{_{−1}});

2. If this line segment does not cross any obstacles:
then the position fix Xₜ_{_{−1}} may be determined to be invalid. Here, backtracker 306 may then return to API 308 an item {{t₋₁, Invalid}} indicating that position fix Xₜ_{_{−1}} has been determined to be invalid, and an item {t₀,Xₜ_{₀}} to indicate a location of a current position fix. Backtracker 306 may then advance to t₊₁;

3. Otherwise, if the projected line segment does not cross any obstacles, backtracker 306 may:

determine a shortest path between locations of position fixes Xₜ_{₀} and Xₜ_{_{−h}}, where h is a backtracking horizon (e.g., a value of h may be selected as a tuning factor and to vary from about four to ten time steps); and

apply a smoothing filter such as a Kalman filter or Kalman smoother as discussed above, smoothing splines or some other technique to generate a smooth, realistic path between Xₜ_{₀} and Xₜ_{_{−h}}. (A shortest path may be used as an initial estimate for the path. The smooth path may be interpolated to provide locations of intermediate position fixes between Xₜ_{₀} and Xₜ_{_{−h}} at the timestamps of the original fixes, that is {t₋₁,Xₜ_{_{−}}}, {t₋₂,Xₜ_{_{−2}}}, . . . , {t₋ₕ₊₁, Xₜ_{_{−h+1}}}.)

In another implementation of backtracker 306, wall/obstacle locations and a pedestrian motion model may be used to further constrain a shape of a smooth trajectory computed from a series of position fixes. For instance, a so-called “repulsive force model” may be used to constrain a smooth path from approaching walls (see, e.g., “Reactive Pedestrian Path Following from Examples,” R. A., Metoher, J. K. Hodgins).

In a particular implementation, API 308 may provide position fix {t₀,Xₜ_{₀}} by default. If backtracking is applied (e.g., as indicated by a message from back tracker 306), then a set of fixes {t₋₁,Xₜ_{_{−1}}},{t₋₂,Xₜ_{_{−2}}}, . . . , {t₋ₕ,Xₜ_{_{−h}}} may be returned to API 308 in addition to a requested current position fix {t₀,Xₜ_{₀}}. Particular implementations of this may be specific to a particular high-level operating system. In a particular implementation where system 300 is hosted on an Android™ platform, for example, such information may be returned as extra information in a bundle class instance. Third-party applications that use API 308 may then choose to use this information for updating path history on a navigation graphical user interface (GUI), for example. It should be understood, however, that these are merely examples of particular implementations on a special purpose computing apparatus, and that claimed subject matter is not limited in this respect.

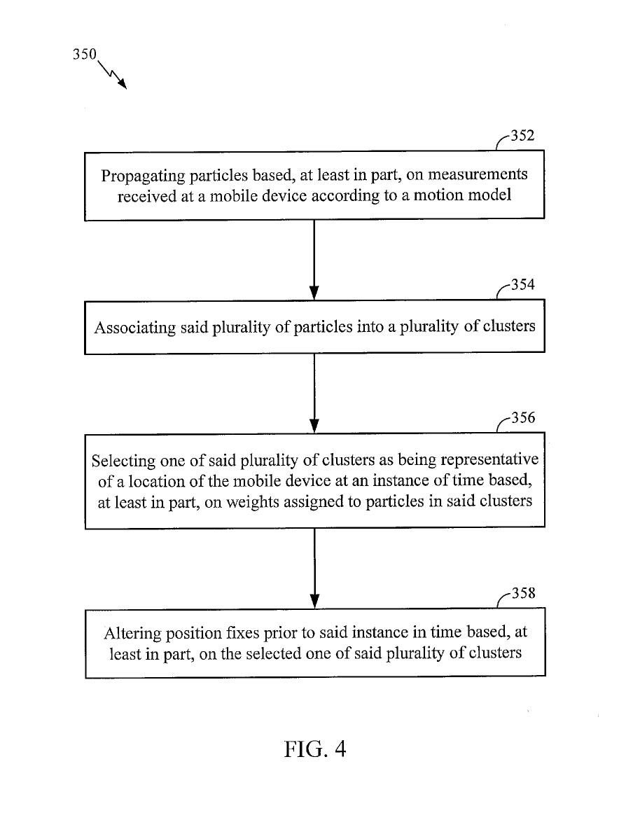

FIG. 4 is a flow diagram of a process 350 for applying post filtering to a tracking filter according to an implementation such as by system 300 described above. In one particular implementation, all or portions of process 350 may be performed by a special purpose electronic computing device such as a mobile computing device. At block 352, particles may be propagated based, at least in part, on measurements received at a mobile device according to a motion model (e.g., at particle filter 302). At block 354, particles may be associated into a plurality of clusters (e.g., at particle clusterer 304). At block 356, one of the clusters may be selected as being representative of a location of the mobile device at an instance of time based, at least in part, on weights assigned to particles in the clusters. At block 358, position fixes at times prior to the instance of time may be altered based, at least in part, on the selected one of the plurality of clusters (e.g., at backtracker 306).

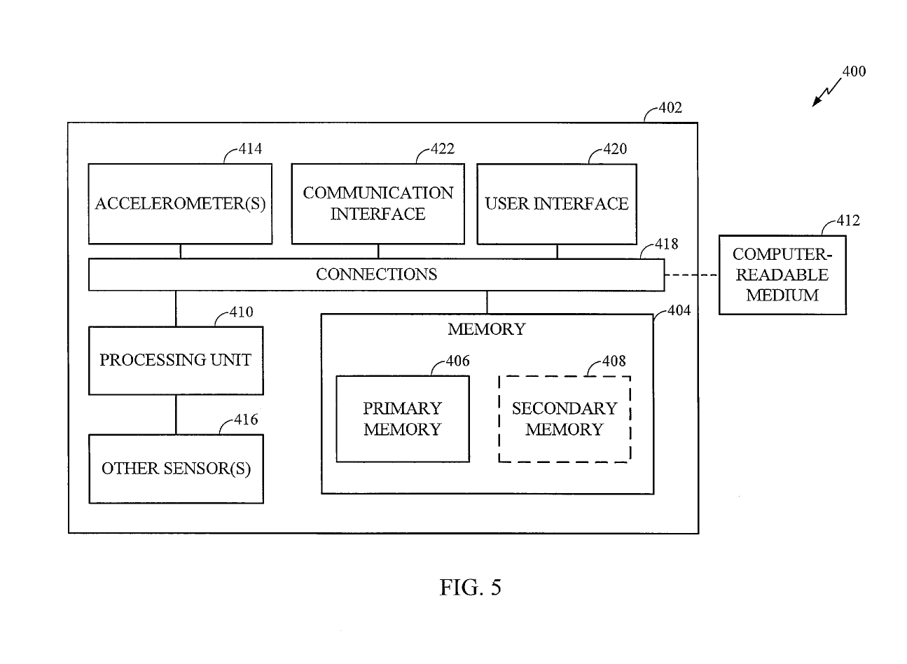

FIG. 5 is a schematic diagram illustrating an implementation of an example computing environment 400 that may include one or more networks or devices capable of partially or substantially implementing or supporting one or more processes for performing particle filtering or post filtering as discussed above. It should be appreciated that all or part of various devices or networks shown in computing environment 400, processes, or methods, as described herein, may be implemented using various hardware, firmware, or any combination thereof along with software.

Computing environment 400 may include, for example, a mobile device 402, which may be communicatively coupled to any number of other devices, mobile or otherwise, via a suitable communications network, such as a cellular telephone network, the Internet, mobile ad-hoc network, wireless sensor network, or the like. In an implementation, mobile device 402 may be representative of any electronic device, appliance, or machine that may be capable of exchanging information over any suitable communications network. For example, mobile device 402 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 402 may take the form of one or more integrated circuits, circuit boards, or the like that may be operatively enabled for use in another device. Although not shown, optionally or alternatively, there may be additional devices, mobile or otherwise, communicatively coupled to mobile device 402 to facilitate or otherwise support one or more processes associated with computing environment 400. Thus, unless stated otherwise, to simplify discussion, various functionalities, elements, components, etc. are described below with reference to mobile device 402 may also be applicable to other devices not shown so as to support one or more processes associated with example computing environment 400.

Computing environment 400 may include, for example, various computing or communication resources capable of providing position or location information with regard to a mobile device 402 based, at least in part, on one or more wireless signals associated with a positioning system, location-based service, or the like. Although not shown, in certain example implementations, mobile device 402 may include, for example, a location-aware or tracking unit capable of acquiring or providing all or part of orientation, position information (e.g., via trilateration, heat map signature matching, etc.), etc. Such information may be provided in support of one or more processes in response to user instructions, motion-controlled or otherwise, which may be stored in memory 404, for example, along with other suitable or desired information, such as one or more threshold values, or the like.

Memory 404 may represent any suitable or desired information storage medium. For example, memory 404 may include a primary memory 406 and a secondary memory 408. Primary memory 406 may include, for example, a random access memory, read only memory, etc. While illustrated in this example as being separate from a processing unit 410, it should be appreciated that all or part of primary memory 506 may be provided within or otherwise co-located/coupled with processing unit 410. Secondary memory 408 may include, for example, the same or similar type of memory as primary memory or one or more information storage devices or systems, such as, for example, a disk drive, an optical disc drive, a tape drive, a solid state memory drive, etc. In certain implementations, secondary memory 408 may be operatively receptive of, or otherwise enabled to be coupled to, a non-transitory computer-readable medium 412.

Non-transitory computer-readable medium 412 may include, for example, any medium that can store or provide access to information, code or instructions (e.g., an article of manufacture, etc.) for one or more devices associated with computing environment 400. For example, computer-readable medium 412 may be provided or accessed by processing unit 410. As such, in certain example implementations, the methods or apparatuses may take the form, in whole or part, of a non-transitory computer-readable medium that may include computer-implementable instructions stored thereon, which are executable by at least one processing unit or other like circuitry, may enable processing unit 410 or the other like circuitry to perform all or portions of a location determination processes, sensor-based or sensor-supported measurements (e.g., acceleration, deceleration, orientation, tilt, rotation, etc.) extraction of features from inertial sensory signals, classifying an activity of a user co-located with a mobile device, or any like processes to facilitate or otherwise support rest detection of mobile device 402. In certain example implementations, processing unit 410 may be capable of performing or supporting other functions, such as communications, gaming, or the like.

Processing unit 410 may be implemented in hardware or a combination of hardware and software. Processing unit 410 may be representative of one or more circuits capable of performing at least a portion of information computing technique or process. By way of example but not limitation, processing unit 410 may include one or more processors, controllers, microprocessors, microcontrollers, application specific integrated circuits, digital signal processors, programmable logic devices, field programmable gate arrays, or the like, or any combination thereof.

Mobile device 402 may include various components or circuitry, such as, for example, one or more accelerometers 414, or various other sensor(s) 416, such as a magnetic compass, a gyroscope, a video sensor, a gravitometer, thermometer or temperature sensor, barometric pressure sensor, ambient light sensor, etc. to facilitate or otherwise support one or more processes associated with operating environment 400. For example, such sensors may provide analog or digital signals to processing unit 410. Although not shown, it should be noted that mobile device 402 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

Although not shown, mobile device 402 may also include a memory or information buffer to collect suitable or desired information, such as, for example, accelerometer measurement information (e.g., accelerometer traces), as previously mentioned. Mobile device may also include a power source, for example, to provide power to some or all of the components or circuitry of mobile device 402. A power source may be a portable power source, such as a battery, for example, or may comprise a fixed power source, such as an outlet (e.g. in a house, electric charging station, car, etc.). It should be appreciated that a power source may be integrated into (e.g., built-in, etc.) or otherwise supported by (e.g., stand-alone, etc.) mobile device 402.

Mobile device 402 may include one or more connections 418 (e.g., buses, lines, conductors, optic fibers, etc.) to operatively couple various circuits together, and a user interface 420 (e.g., display, touch screen, keypad, buttons, knobs, microphone, speaker, trackball, data port, etc.) to receive user input, facilitate or support sensor-related signal measurements, or provide information to a user. In particular example implementations, user interface 420 may comprise a display capable of showing plots of mobile device trajectories computed from position fixes laid over a map of an indoor area as part of a navigation application as discussed above. Mobile device 402 may further include a communication interface 422 (e.g., wireless transmitter or receiver, modem, antenna, etc.) to allow for communication with one or more other devices or systems over one or more suitable communications networks, as was indicated.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or information as expressed by a particular state of the storage media. For example, an electronic signal representative of data or information may be “stored” in a portion of the storage media (e.g., memory) by affecting or changing the state of such portions of the storage media to represent data or information as binary information (e.g., ones and zeros). As such, in a particular implementation, such a change of state of the portion of the storage media to store a signal representative of data or information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN),a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2”(3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In one particular implementation, a mobile device may, for example, be capable of communicating with one or more femtocells facilitating or supporting communications with the mobile device for the purpose of estimating its location, orientation, velocity, acceleration, or the like. As used herein, “femtocell” may refer to one or more smaller-size cellular base stations that may be enabled to connect to a service provider's network, for example, via broadband, such as, for example, a Digital Subscriber Line (DSL) or cable. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA) -2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions or data may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
propagating particles based, at least in part, on measurements received at a mobile device according to a motion model;
associating said plurality of particles into a plurality of clusters;
selecting one of said plurality of clusters as being representative of a location of the mobile device at an instance of time based, at least in part, on weights assigned to particles in said clusters; and
altering position fixes prior to said instance in time based, at least in part, on the selected one of said plurality of clusters.

2. The method of claim 1, wherein associating said plurality of particles into a plurality of clusters comprises applying Affinity Propagation Clustering.

3. The method of claim 1, wherein associating said plurality of particles into a plurality of clusters comprises:
determining polygonal patches on a floor plan; and
for each polygonal patch, determining which particles are located in the polygonal patch.

4. The method of claim 1, and further comprising applying a smoothing filter to said altered position fixes occurring prior to said instance in time.

5. The method of claim 4, wherein said smoothing filter comprises a Kalman filter.

6. The method of claim 1 and further comprising applying a Kalman smoother to said altered position fixes occurring prior to and subsequent to said instance in time.

7. The method of claim 1, wherein altering the position fixes further comprises applying a backtracking process to said position fixes.

8. The method of claim 1, and further comprising determining a current position fix based, at least in part, on a computed center of the selected cluster.

9. The method of claim 8, and further comprising determining whether an immediately previous position fix is feasible based, at least in part, on whether there are any obstructions located between the current and immediately previous position fix.

10. The method of claim 1, and further comprising altering position fixes following said instance in time based, at least in part, on the selected one of said plurality of clusters.

11. A mobile device comprising:
at least one sensor; and
a processor to:
propagate particles based, at least in part, on measurements obtained from said at least one sensor according to a motion model;
associate said plurality of particles into a plurality of clusters;
select one of said plurality of clusters as being representative of a current position of the mobile device based, at least in part, on weights assigned to particles in said clusters; and
alter past position fixes based, at least in part, on the selected one of said plurality of clusters.

12. The mobile device of claim 11, wherein said processor is further to associate said plurality of particles into a plurality of clusters by applying Affinity Propagation Clustering.

13. The mobile device of claim 11, wherein said processor is further to associate said plurality of particles into a plurality of clusters by:
determining polygonal patches on a floor plan; and
for each polygonal patch, determining which particles are located in the polygonal patch.

14. The mobile device of claim 11, wherein said processor is further to apply a smoothing filter to said altered position fixes occurring prior to said instance in time.

15. The mobile device of claim 14, wherein said smoothing filter comprises a Kalman filter.

16. The mobile device of claim 11, where said processor is further to apply a Kalman smoother to said altered position fixes occurring prior to and subsequent to said instance in time.

17. The mobile device of claim 11, wherein said processor is to alter the position fixes by applying a backtracking process to said position fixes.

18. The mobile device of claim 11, wherein said processor is further to determine a current position fix based, at least in part, on a computed center of the selected cluster.

19. The mobile device of claim 18, wherein said processor is further to determine whether an immediately previous position fix is feasible based, at least in part, on whether there are any obstructions located between the current and immediately previous position fix.

20. The mobile device of claim 11, wherein said processor is further to alter position fixes following said instance in time based, at least in part, on the selected one of said plurality of clusters.

21. An article comprising:
a non-transitory storage medium comprising machine-readable instructions stored thereon which are executable by a special purpose computing apparatus to:
propagate particles based, at least in part, on measurements received at a mobile device according to a motion model;
associate said plurality of particles into a plurality of clusters;
select one of said plurality of clusters as being representative of a current position of the mobile device based, at least in part, on weights assigned to particles in said clusters; and
alter past position fixes based, at least in part, on the selected one of said plurality of clusters.

22. The article of claim 21, wherein said instructions are further executable by said special purpose computing apparatus to associate said plurality of particles into a plurality of clusters by applying Affinity Propagation Clustering.

23. The article of claim 21, wherein said instructions are further executable by said special purpose computing apparatus to associate said plurality of particles into a plurality of clusters by:
determining polygonal patches on a floor plan; and
for each polygonal patch, determining which particles are located in the polygonal patch.

24. The article of claim 21, wherein said instructions are further executable by said special purpose computing apparatus to apply a smoothing filter to said altered position fixes occurring prior to said instance in time.

25. The article of claim 24, wherein said smoothing filter comprises a Kalman filter.

26. The article of claim 21, where said instructions are further executable by said special purpose computing apparatus to apply a Kalman smoother to said altered position fixes occurring prior to and subsequent to said instance in time.

27. The article of claim 21, wherein said instructions are further executable by said special purpose computing apparatus to alter the position fixes by applying a backtracking process to said position fixes.

28. The article of claim 21, wherein said instructions are further executable by said special purpose computing apparatus to determine a current position fix based, at least in part, on a computed center of the selected cluster.

29. The article of claim 28, wherein said instructions are further executable by said special purpose computing apparatus to determine whether an immediately previous position fix is feasible based, at least in part, on whether there are any obstructions located between the current and immediately previous position fix.

30. The article of claim 21, wherein said processor is further to alter position fixes following said instance in time based, at least in part, on the selected one of said plurality of clusters.

31. An apparatus comprising:
means for propagating particles based, at least in part, on measurements received at a mobile device according to a motion model;
means for associating said plurality of particles into a plurality of clusters;
means for selecting one of said plurality of clusters as being representative of a current position of the mobile device based, at least in part, on weights assigned to particles in said clusters; and
means for altering past position fixes based, at least in part, on the selected one of said plurality of clusters.

32. The apparatus of claim 31, wherein said means for associating said plurality of particles into a plurality of clusters comprises means for applying Affinity Propagation Clustering.

33. The apparatus of claim 31, wherein said means for associating said plurality of particles into a plurality of clusters comprises:
means for determining polygonal patches on a floor plan; and
for each polygonal patch, means for determining which particles are located in the polygonal patch.

34. The apparatus of claim 31, and further comprising means for applying a smoothing filter to said altered position fixes occurring prior to said instance in time.

35. The apparatus of claim 34, wherein said smoothing filter comprises a Kalman filter.

36. The apparatus of claim 31, and further comprising means for applying a Kalman smoother to said altered position fixes occurring prior to and subsequent to said instance in time.

37. The apparatus of claim 31, wherein said means for altering the position fixes further comprises means for applying a backtracking process to said position fixes.

38. The apparatus of claim 31, and further comprising means for determining a current position fix based, at least in part, on a computed center of the selected cluster.

39. The apparatus of claim 38, and further comprising means for determining whether an immediately previous position fix is feasible based, at least in part, on whether there are any obstructions located between the current and immediately previous position fix.

40. The apparatus of claim 31, and further comprising means for altering position fixes following said instance in time based, at least in part, on the selected one of said plurality of clusters.
